(19) United States
(12) Patent Application Publication
(10) Pub. No.: US 2015/0141036 A1
(43) Pub. Date: May 21, 2015

(54) METHOD AND APPARATUS FOR ESTIMATING TRAFFIC SPEED

(71) Applicant: AT&T Mobility II LLC, Atlanta, GA (US)

(72) Inventors: Jeremy Fix, Acworth, GA (US); Sheldon Kent Meredith, Marietta, GA (US); Rick Tipton, Carryton, TN (US)

(73) Assignee: AT&T Mobility II LLC, Atlanta, GA (US)

(21) Appl. No.: 14/084,555

(22) Filed: Nov. 19, 2013

(51) Int. Cl. H04W 64/00

(52) U.S. Cl. CPC H04W 64/00
USPC 455/456.1

(57) ABSTRACT

A method, computer-readable storage device and an apparatus for estimating the traffic speed for segments of roads using location information of wireless devices in a wireless network are disclosed. For example, the method computes a speed and a speed error for travelling between at least two locations of the plurality of locations, correlates the speed and speed error with one or more segments of one or more roads, aggregates the speed and the speed error that are correlated with the respective segment of the respective road, within a pre-determined time interval, computes an average speed, a composite speed error, and a speed variance to a predefined accuracy level for the respective segment of the respective road, in accordance with the plurality of speeds and speed errors that are correlated with the respective segment of the respective road, and provides the average speed as the traffic speed.

### BACKGROUND

A customer of a wireless service provider may wish to receive information regarding traffic speed for segments of a road. For example, the customer may be driving and may wish to know how fast traffic is moving on a road that the customer may want to use. The information on traffic speed may be beneficial to the customer in selecting a particular road from a plurality of roads that may be available for reaching a destination.

### SUMMARY OF THE DISCLOSURE

In one embodiment, the present disclosure describes a method, computer-readable storage device, and apparatus for estimating the traffic speed for segments of roads using location information of wireless devices in a wireless network. For example, the method receives a plurality of locations of a plurality of mobile user endpoint devices, computes for each respective mobile user endpoint device, a speed and a speed error for travelling between at least two locations of the plurality of locations that are received for each respective mobile user endpoint device, correlates the speed and speed error that are computed for each respective user endpoint device with one or more segments of one or more roads, aggregates for each respective segment of each respective road, the speed and the speed error that are correlated with the respective segment of the respective road, within a pre-determined time interval, computes for each respective segment of the respective road, an average speed, a composite speed error, and a speed variance to a predefined accuracy level for the respective segment of the respective road, in accordance with the plurality of speeds and speed errors that are correlated with the respective segment of the respective road, and provides the average speed as the traffic speed for each respective segment of the respective road.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2. illustrates a flowchart of a method for estimating the traffic speed for segments of roads using location information of wireless devices in a wireless network; and

FIG. 3 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly describes a method, computer-readable storage device, and apparatus for estimating the traffic speed for segments of roads using location information of wireless devices in a wireless network. Although the teachings of the present disclosure are discussed below in the context of a long term evolution (LTE) based wireless network, the teaching is not so limited. Namely, the teachings of the present disclosure can be applied for customers of other types of wireless networks (e.g., 2G network, 3G network, and the like).

Broadly defined, 3GPP is a global effort to define a wireless communication system specification. 2G is a second generation cellular network technology, 3G is a third generation cellular network technology, and 4G is a fourth generation cellular network technology. A Global System for Mobile (GSM) communications is an example of a 2G cellular technology and a Universal Mobile Telecommunications System (UMTS) is an example of a 3G cellular network technology. In accordance with the 3GPP global effort, a General Packet Radio Service (GPRS) refers to a communications service used to transfer data via a cellular network. GPRS is available to users of a 2G cellular system GSM. The GPRS provides an enhancement to the GSM system so that data packets are supported. In addition, in 3GPP release 8, an LTE is provided as a set of enhancements to the UMTS. The enhancement focuses on adopting 4th Generation (4G) mobile communications technology to include an all Internet Protocol (IP) end-to-end networking architecture. An LTE is an example of a 4G cellular network technology.

A base station for a 2G network is also referred to as a base transceiver station (BTS). A base station in a 3G network is also referred to as a Node B. For the 4G network, a radio base transceiver station (RBS), as per the 3GPP standards, is referred to as an eNodeB (or simply as a base station). An eNodeB provides an LTE—air interface and performs radio resource management for wireless access.

In one embodiment, a Serving GPRS Support Node (SGSN) refers to a network node responsible for communicating with user endpoint devices and routing of data calls. For example, the SGSN may send and receive data packets to and from user endpoint devices in the coverage area of the SGSN.

In one embodiment, a Gateway GPRS Support Node (GGSN) refers to a network node responsible for the interworking between the GPRS network and external packet switched networks, e.g., the Internet. The GGSN converts the GPRS packets coming from the SGSN into the packet data protocol (PDP) format of the external packet network. For example, the GPRS packet may be converted to an Internet Protocol packet prior to being sent to the external network, which is Internet Protocol based.

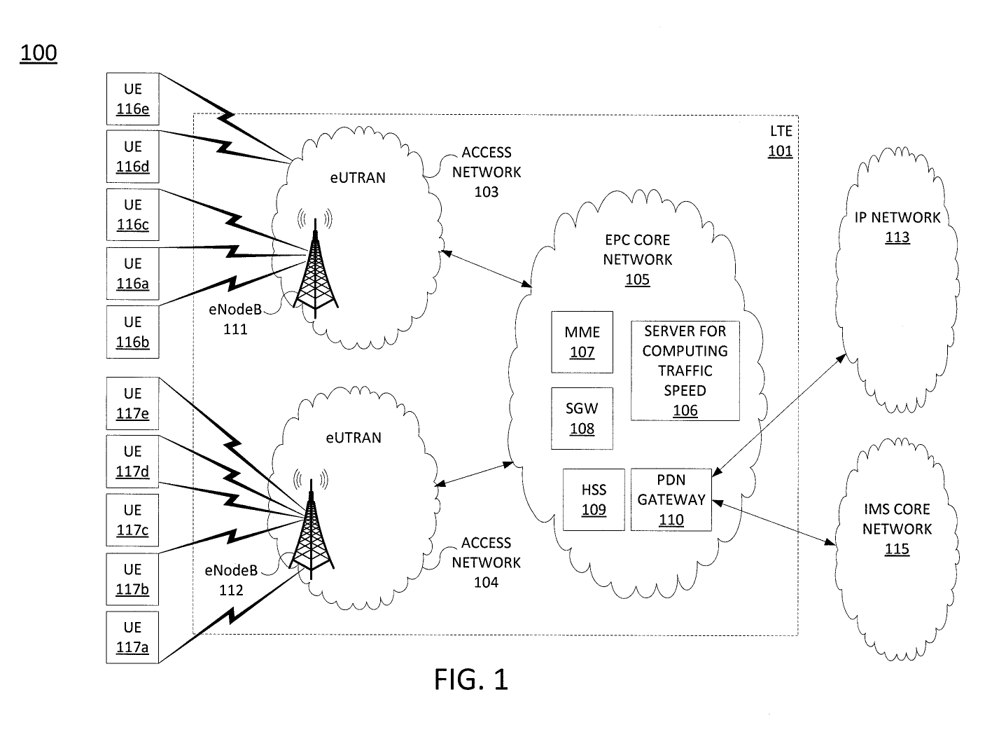

FIG. 1 illustrates an exemplary network 100 related to the present disclosure. In one illustrative embodiment, the network 100 comprises an LTE network 101, an IP network 113, and a core network 115, e.g., an IMS core network. FIG. 1 also illustrates various user endpoint devices, e.g., LTE user endpoint devices 116a-e and 117a-e. Each of the user endpoint devices 116a-e and 117a-e can be a smart phone, a cellular phone, a computing tablet, a computer or laptop, or any endpoint communication devices equipped with wireless capabilities.

In one illustrative embodiment, the LTE network 101 comprises access networks 103 and 104 and a core network 105. In one example, each of the access networks 103 and 104 comprises an evolved Universal Terrestrial Radio Access Network (eUTRAN). In one example, the core network 105 comprises an Evolved Packet Core (EPC) network.

The eUTRANs are the air interfaces of the 3GPP's LTE specifications for mobile networks. Namely, the eUTRAN comprises a radio access network standard that will replace previous generations of air interface standards. All eNodeBs in the eUTRANs 103 and 104 are in communication with the EPC network 105. In operation, LTE user equipment or user endpoints (UE) 116a-e may access wireless services via the eNodeB 111 located in the eUTRAN 103. Similarly, the LTE UEs 117a-e may access wireless services via the eNodeB 112 located in the eUTRAN 104.

It should be noted that any number of eNodeBs can be deployed in an eUTRAN. In one illustrative example, the eUTRANs 103 and 104 may comprise one or more eNodeBs.

An EPC network provides various functions that support wireless services in the LTE environment. In one embodiment, an EPC network is an Internet Protocol (IP) packet core network that supports both real-time and non-real-time service delivery across a LTE network, e.g., as specified by the 3GPP standards.

In EPC network 105, a server 106 (e.g., an application server) for computing traffic speed on segments of roads and providing such speed information to customers, a network device Mobility Management Entity (MME) 107, and a Serving Gateway (SGW) 108, support various functions as part of the LTE network 101. For example, the server 106 may be used for estimating the traffic speed (e.g., an average speed) for a segment of a road and providing such speed information to customers who are traveling on the particular segment of the road for which the traffic speed is computed. For example, customers accessing services via UEs 116-a-e and 117a-e may receive traffic speed information from server 106 of the service provider. The MME 107 is the control node for the LTE access-network. In one embodiment, it is responsible for UE (User Equipment) tracking and paging (e.g., such as retransmissions), bearer activation and deactivation process, selection of the SGW, and authentication of a user. In one embodiment, SGW 108 routes and forwards user data packets, while also acting as the mobility anchor for the user plane during inter-eNodeB handovers and as the anchor for mobility between LTE and other wireless technologies, such as 2G and 3G wireless networks.

In addition, EPC (common backbone) network 105 may comprise a Home Subscriber Server (HSS) 109 that contains subscription-related information (e.g., subscriber profiles), performs authentication and authorization of a wireless service user, and provides information about the subscriber's location. The EPC network 105 may also comprise a public data network gateway 110 which serves as a gateway that provides access between the EPC network 105 and various data networks, e.g., other IP networks 113, an IMS core network 115, a network management system (not shown) and the like. The public data network gateway is also referred to as a PDN gateway, a PDN GW or a PGW.

It should be noted that although various networks are shown as separate networks in FIG. 1, it is possible that functions performed by these networks can be combined into fewer networks or expanded into a greater number of networks depending on the deployment requirements.

It should also be noted that the above illustrated network 100 is only illustrative and the number of network components or elements are not specifically limited as shown. Any number of network components or elements can be deployed.

As described above, a customer of a wireless service provider may wish to receive information regarding traffic speeds for various segments of one or more roads. For example, the customer may be driving and may wish to know how fast traffic is moving on any number of roads (routes) that the customer may wish to use to reach a destination. With such speed information, the customer may then be able select a particular road or road segment in an informed manner to reach his/her destination based on the speed information that is received.

One way the customer may receive information regarding traffic speeds is from companies that provide such services, e.g., Google. However, the traffic speed information received from these companies is not very accurate due to the fact that these companies use very few inputs to make their traffic speed projections.

For example, Global Positioning System (GPS) data can be collected from mobile endpoint devices. These mobile endpoint devices may transmit their longitudinal and latitudinal location information to be used for the calculation of traffic speed projections. However, improving the accuracy of the traffic speed projections would require receiving GPS data from many mobile endpoint devices.

One approach for receiving GPS data from more endpoint devices is to have a large number of customers turning on the GPS receivers on their respective endpoint devices and transmitting the results. However, turning on the GPS receivers on an ongoing basis would reduce the battery life of the endpoint devices. Thus, most customers prefer not to have the GPS receivers turned-on for any significant amount of time.

Another approach for receiving GPS data from more endpoint devices is crowd sourcing information from wireless fidelity (Wi-Fi) transmitters. However, in most geographical areas, the user endpoint devices are not within the range of a Wi-Fi transmitter.

In one embodiment, the present disclosure describes a method, computer-readable storage device, and an apparatus for providing the traffic speed information to customers, wherein the traffic speed information is determined based on location information that is available to wireless network service providers. The wireless network service providers have access to the GPS data as discussed above. However, the wireless network service providers also have access to location information from several other sources. For example, a wireless network service provider may have location information that is obtained from one or more of: a Network Event Location System (NELOS), proximity information relative to Wi-Fi networks, proximity information relative to a cell tower (e.g., a base station), proximity information relative to femto-cells, triangulation data, differential GPS information, cell radio identifications, etc. The location information obtained from the various sources comprises information of varying levels of accuracy. For example, location information based on proximity to a Wi-Fi network may be accurate to 50-100 m, location information based on GPS may be accurate to 1-10 m, location information based on proximity to base-stations may be accurate to hundreds of meters, and so on. The method of the present disclosure estimates the traffic speed for segments of roads while accounting for the variations in the levels of accuracy associated with the location information obtained from the various sources.

In order to estimate the traffic speed for segments of roads, information pertaining to the segments of the roads need to be developed or acquired. The present disclosure utilizes existing maps of various roads as a data source that provides geographic information for each of the roads. For example, electronic road maps are readily available for many countries including the U.S. For example, U.S. Government census data, Navteq, and TeleAtlas are sources of road maps that may be used for defining the segments of roads. The road maps may provide information that comprises one or more of:
Directions or Orientation of traffic, e.g., one-way road, two-way road, north bound, south bound, east bound, west bound, and the like;
Speed limits;
Road segments, e.g., based on physical distances, exit numbers and the like;
Road names and road identifications;
Representations of roads as multi-point line strings;
Order of road segments; and
Layering of road segments.

Road segments for roads in cities may be represented in shorter segments while road segments for interstate highways may be represented in longer segments. For example, a road segment in a city may be 75 m long. In another example, a road segment of an interstate highway may be 250 m long. The order of road segments may be used for determining which segments are adjacent to each other. The layering of road segments enables integrating and reporting functions. For example, a particular segment may only be a very small portion of an interstate highway. The speed to be reported may be the average speed for a larger portion of the interstate highway, e.g., comprising a plurality of segments.

In one embodiment, the method of the present disclosure may develop the road segments, using the information obtained from the maps described above, by first parsing a line string representing a road and creating point-to-point road segments. The method may evenly split large road segments into smaller segments. For example, segments greater than 250 m may be split into a plurality of smaller segments, with each of the smaller segments having a length less than 250 m. The method then calculates and records an angular direction for each resulting road segment.

In one embodiment, the method receives location information from various user endpoint devices (various sources). The method computes a speed for each particular user endpoint device based on the location information received for the particular user endpoint device. The method then computes an expected error on the speed that is computed. The expected error on the speed is based on the level of accuracy of the location information obtained for the particular user endpoint device.

Note that, once the segments are established, the problem may be re-defined as a problem of estimating traffic speeds on each segment. Since the users are traversing the segments only for a limited duration before reaching their destination, some portions of the data gathered for every user are clearly not suitable for the determination of traffic speeds on roads. For example, the user has arrived in a building and is no longer on a road segment. In another example, the time at which the location data was gathered may no longer be time relevant. For example, receiving location information pertaining to a time period 30 minutes ago may not be useful since the data is now stale. In yet another example, only one location may have been reported for a user. Hence, a speed, which is defined as a distance between two locations divided by a change in time, cannot be calculated with just one location reported.

Thus, the method may perform some pre-processing on the gathered location information. The pre-processing first establishes a time interval for determining the traffic speed and rules for inclusion and exclusion of reported locations. For example, the method may establish a rule for determining the speed for 15 minute intervals, and establish a rule for including locations reported up to 100 seconds prior to a start of the 15 minute interval. The pre-processing may also include filtering out locations reported within buildings, eliminating locations of particular customers wherein only one location is reported for each of the particular customers, etc.

The method then determines road segments for a location using one of the following two possible approaches to first identify potential road segments, based on whether the location has been determined in a past time frame:

(1) If the road segments for a location have not been previously determined, the method performs a search for potential road segments that lie within a spherical distance for a location. The method then develops a table for storing road segments for the purpose of optimizing the search. In one embodiment, when performing a geospatial search, the method develops a Tessellation object to optimize the search for potential road segments for each location. The Tessellation object limits the search to a common 10 Km Military Grid Reference System (MGRS) bin of the location and road segments. The location may have up to 600 m of error. Hence, the road segment is expanded to 11.2 Km bin. That is, a 5.6 Km square buffer is established from the center of the 10 Km MGRS bin. This technique ensures that all road segments are captured for a location that are reported along the perimeter of the bin with an accuracy error of up to 600 m. In order to search for the potential road segments, the location and the potential road segments need to have the same 10 Km MGRS bin and the potential road segments need to exist within the spherical distance of the accuracy error of the location.

(2) If the road segments for a location have previously been determined, the method performs a lookup to locate against a history table. The history table stores previously searched results of the location as described in (1). The logical key of the table is the MGRS bin and the accuracy error. The method then develops an algorithm that applies the bin and the accuracy error lookup for 95% of rows of the locations. In order to continuously refresh the lookup table, 5% of the rows of the locations are randomly assigned on the lookup table to perform a search for road segments as described above in (1).

The method then computes a shortest spherical distance from the location to each potential road segment. The method then determines the road and the shortest distance point on the road for each location as described below:

(1) The method sorts the locations reported for the user by timestamps.

(2) Using the locations reported for a user within a pre-determined time window of the user being located at a location Lₙ, the method determines potential roads associated with the location Lₙ.

(3) Using the timestamps that are reported for the user, the method determines the closest location L_{c} for the user.

(4) The method then determines potential roads and shortest distance points Pₙ and P_{c}, on each road between locations Lₙ and L_{c}.

(5) The method then resolves the road and the shortest distance point on the road for location Lₙ, by iteratively continuing to find the next closest location within the pre-determined time window, and repeating steps (3) to (5) until the method successfully establishes a common road between the locations Lₙ and L_{c}.

In one embodiment, resolving of the road and the shortest distance point on the road for location Lₙ is performed based on a number of common roads between the locations Lₙ and L_{c}, as described below:

If there are no common roads between the locations Lₙ and L_{c}, the location Lₙ is not assigned to a road.

If there is one common road between the locations Lₙ and L_{c}, the method looks up for the shortest distance point Pₙ on the one road and assigns the location Lₙ to the point Pₙ. Note that the shortest distance points Pₙ for the potential road were determined above.

If there are two common roads between the locations Lₙ and L_{c}, the method uses a road score algorithm or method to first select a common road from the two common roads. Then, the method looks up for the shortest distance point Pₙ on the selected road. The method then assigns the location Lₙ to the point Pₙ, on the selected road.

In one embodiment, the road score algorithm or method for selecting a common road from two common roads is implemented as follows:

(i) First, the two roads are assigned identifications, for ease of reference, e.g., road A and road B.

(ii) Then, relative distances are computed for the locations Lₙ and L_{c} to each of the roads, e.g., to each of the roads A and B. For example, for the location Lₙ, the relative distance of Lₙ to road A versus to road B may be computed as a ratio of shortest distance between Lₙ and road A to the shortest distance between Lₙ and road B. If the ratio is represented as “1a”, then

$$1 a = \frac{shortest distance between {L}_{n} and road A}{shortest distance between {L}_{n} and road B} .$$

Similarly, a relative distance of Lₙ to road B versus to road A may be computes as a ratio of shortest distance between Lₙ and road B to the shortest distance between Lₙ and road A. If the ratio is represented as “2a”, then

$$2 a = \frac{shortest distance between {L}_{n} and road B}{shortest distance between {L}_{n} and road A} .$$

Similarly, for location L_{c}, the the relative distance of L_{c} to road A versus to road B may be computed as a ratio of shortest distance between L_{c} and road A to the shortest distance between L_{c} and road B. If the ratio is represented as “1b”, then

$$1 b = \frac{shortest distance between {L}_{c} and road A}{shortest distance between {L}_{c} and road B} .$$

Similarly, a relative distance of L_{c} to road B versus to road A may be computes as a ratio of shortest distance between L_{c} and road B to the shortest distance between L_{c} and road A. If the ratio is represented as “2b”, then

$$2 a = \frac{shortest distance between {L}_{c} and road B}{shortest distance between {L}_{c} and road A} .$$

(iii) Then, the score for each of the particular roads A and B are computed as the average of the relative distances from the locations Lₙ and L_{c} to the particular roads. For example, the score for road A is equal to the average of 1a and 1b. That is, score of road

$$A = \frac{( 1 a + 1 b )}{2} .$$

Similarly, the score of road B is equal to the average of 2a and 2b.

(iv) Then, the road with the lower score is selected as the common road between the locations Lₙ and L_{c}.

If there are more than two common roads between the locations Lₙ and L_{c}, the method uses the road score algorithm described above once the two closest common roads are determined using the average shortest distance from the locations to the common roads. For example, if there are four common roads between the locations Lₙ and L_{c}, the method first computes the shortest average distance as described below:

(i) First, the four roads are assigned identifications, for ease of reference, e.g., roads A, road B, road C, and road D.

(ii) The method then determines the shortest distance from each of the locations Lₙ and L_{c} to each of the roads, A through D. For example, the shortest distance to road A from the location Lₙ may be represented by “d1A”. The shortest distance to road A from the location L_{c} may be represented by “d2A”. The shortest distance to road B from the location Lₙ may be represented by “d1B”. The shortest distance to road B from the location L_{c} may be represented by “d2B”. The shortest distance to road C from the location Lₙ may be represented by “d1C”. The shortest distance to road C from the location L_{c} may be represented by “d2C”. The shortest distance to road D from the location Lₙ may be represented by “d1D”. The shortest distance to road D from the location L_{c} may be represented by “d2D”.

(iii) The method then computes average distances from the locations Lₙ and L_{c} to each of the roads. For example, the method computes the averages to each of the roads A through D as:

Average to road A=(d1A+d2A)/2;

Average to road B=(d1B+d2B)/2;

Average to road C=(d1C+d2C)/2; and

Average to road D=(d1D+d2D)/2.

(iv) The method then selects the two roads with the smallest average distances. Then, the method selects one road from the two roads using the road score algorithm described above.

Once the common road between the locations Lₙ and L_{c} is successfully established, the method then assigns all the locations that appear chronologically between the locations Lₙ and L_{c}, to their respective shortest distance points on the same road.

The method then computes, for each user, speed and speed error for travelling between the locations Lₙ and L_{c}. The speed is computed as the change in location (distance) on the particular road the locations Lₙ and L_{c} are assigned divided by the change in time. For example, the speed may be computed as the distance between points Pₙ and P_{c} divided over delta time. The speed error is computed using the location accuracy error of each of the points Pₙ and P_{c}. For example, the speed error may be computed as:

$$\frac{\sqrt{{( error at {P}_{n} )}^{2} + {( error at {P}_{c} )}^{2}}}{delta time} .$$

In one embodiment, the method of the present disclosure limits the time interval between two locations used for speed computation. For example, the time interval may be at minimum 5 seconds and at most 100 seconds.

In one embodiment, the method of the present disclosure limits the speed for a segment of a road to a range of values. For example, the speed may be considered valid only if, 5 mph≦speed≦100 mph.

The speed, for each user, may be computed between two locations that are not consecutive, as long as the computations comply with the rules above. For example, even if the locations are not consecutive, if the road is the same and the time interval is still within the 100 seconds, the speed may be computed the same way. In addition, the speed may be computed for overlapping locations. Thus, the method eliminates the possibility of assigning multiple speed values to the same road segment. For example, if multiple speeds may be computed for a road segment, the road segment may be assigned the speed associated with the first reported location.

The method then correlates the speed of each particular user and the expected error that is computed for the particular user with one or more segments of one or more roads, wherein the one or more segments of the one of more roads are between the locations used for computing the speed of the particular user endpoint device.

Once, a plurality of speeds of users is correlated with a particular segment within a particular time interval, the plurality of speeds are sorted based on accuracy. For example, the speeds and the associated expected errors may be recorded in a sorted order, beginning with the most accurate speed, proceeding to the second most accurate speed, followed by the third most accurate speed, etc., until the least accurate speed is recorded.

The average speed, composite speed error, and speed variance are then determined to the most accurate level for the particular segment, in accordance with the plurality of speeds of users that are correlated with the particular speed. In order to clearly describe the operations for computing the average speed, speed error and speed variance, the mathematical operations are first described below:

The average speed is computed as the averages of the speeds of the plurality of users used in the computation. For example, if two speeds are used, the average speed is computed as the sum of the two speeds divided by two. In general, if there are m speeds are used, the average speed is computed by first adding the m speeds and dividing the sum by m.

The composite speed error is computed by first computing the square root of the sum of the squares of the expected errors, and then dividing the result by the number of speeds. For example, for the m speeds used above, the composite speed error is computed as:

$$\frac{\sqrt{\begin{matrix}{( expected error of first user )}^{2} + \\ {( expected error of second user )}^{2} + ⋯ + \\ {( expected error of mth user )}^{2}\end{matrix}}}{m} .$$

The speed variance is computed as the average squared deviation of each speed from the average speed. For example, for the m speeds above, the average speed is computed as described above. Then, the speed variance is computed as:

$$Speed variance = \frac{\begin{matrix}{( first speed - average speed )}^{2} + \\ {( second speed - average speed )}^{2} + ⋯ + \\ {( mth speed - average speed )}^{2}\end{matrix}}{m} .$$

In order to insure that the speed is computed to the most accurate level (broadly a predefined accuracy level), the method computes a series of composite speed errors, until a minimum value is determined for the composite speed error. For example, the method first computes the average speed using only a speed of a first user and the corresponding expected error, wherein the first user is the user with the best accurate speed from among the plurality of users. The first Composite Speed Error (CSE) is then computed based on the expected error of the first user.

The method then attempts to improve the computed speed by including a speed of a second user, wherein the second user is the user with the second best accurate speed from among the plurality of users. The method then computes a second CSE based on the expected errors of the first and second users. The second CSE is then compared to the first CSE.

If the second CSE is less than the first CSE, then including the speed of the second user would improve the accuracy of an average speed that would have been based on only the speed of the first user. Thus, the method computes the average speed, the speed variance and the composite speed error based on the speeds and expected errors of the first and second users. The method then proceeds to attempt to further improve the accuracy of the computed speed by including a speed of a third user, wherein the third user is the user with the third best accurate speed from among the plurality of users.

If the second CSE is greater than the first CSE, then including the speed of the second user would only contribute to a degradation of the accuracy of an average speed that would have been based on only the speed of the first user. Thus, the method computes the average speed, speed variance and speed error for the segment based on only the data of the first user.

The attempt to improve on the accuracy of the computed speed continues by including more and more speeds of users, until including a particular speed results in a degradation of the accuracy of the average speed. Then, the method computes the average speed, speed variance and speed error for the segment without the speed of that particular user. For example, if the nth speed is the first one to degrade the accuracy of the average speed, the method computes the average speed, speed variable and speed error based on the 1^{st}, 2^{nd} (n-1)^{th} speeds of users and their respective expected errors.

The example in Table-1, below, illustrates how the computation of the CSE would proceed if the following speeds and expected errors are available for twelve users for a particular segment.

TABLE 1
Example of user input for computing CSE

| User | Speed in Km/hr | Expected Error in Km/hr |
|---|---|---|
| 1 | 100 | 10 |
| 2 | 80 | 10 |
| 3 | 90 | 10 |
| 4 | 110 | 10 |
| 5 | 80 | 15 |
| 6 | 90 | 15 |
| 7 | 88 | 15 |
| 8 | 105 | 30 |
| 9 | 81 | 40 |
| 10 | 95 | 50 |
| 11 | 100 | 60 |
| 12 | 110 | 70 |

The first CSE is computed using only the first user's data. Then, the first CSE is set to 10. Then, the second CSE is computed using the expected errors of the first and the second users. The second CSE is then equal to 7.07. Since the second CSE is less than the first CSE, the method proceeds to compute a third CSE using the expected errors of the first through the third users. The third CSE is then determined as being equal to 5.77. Since the third CSE is less than the second CSE, including the data of the third user improves the accuracy of the speed calculated for the segment. The method then proceeds to compute a fourth CSE using the expected errors of the first through the fourth users. The fourth CSE is then determined as being equal to 5.00. Since the fourth CSE is less than the third CSE, including the data of the fourth user improves the accuracy of the speed calculated for the segment. The method then proceeds to compute a fifth CSE using the expected errors of the first through the fifth users. The fifth CSE is then determined as being equal to 5.00. Since the fifth CSE is the same as the fourth CSE, including the data of the fifth user does not degrade or improve the speed calculated for the segment. The method then proceeds to compute a sixth CSE using the expected errors of the first through the sixth users. The sixth CSE is then determined as being equal to 4.86. Since the sixth CSE is less than the fifth CSE, including the data of the sixth user improves the speed calculated for the segment. The method then proceeds to compute a seventh CSE using the expected errors of the first through the seventh users. The seventh CSE is then determined as being equal to 4.68. Since the seventh CSE is less than the sixth CSE, including the data of the seventh user improves the speed calculated for the segment. The method then proceeds to compute an eighth CSE using the expected errors of the first through the eighth users. The eighth CSE is then determined as being equal to 5.56. Since the eighth CSE is greater than the seventh CSE, including the data of the eighth user degrades the accuracy of the speed calculated for the segment.

The method then sets the average speed for the segment as the average of the speeds of the first through the seventh users. The speed variance is then computed based on the speeds of the first through the seventh users, and the average of the speeds of the first through the seventh users. The CSE that is retained is clearly the 7^{th} CSE, since the 8^{th} CSE would only degrade the accuracy.

In one embodiment, once all the average speeds are computed for each segment, the method applies an algorithm for smoothing the values of the average speeds on adjacent segments on a road. For example, the method may apply an algorithm that computes the average speed of a particular segment using an algorithm to compute the average speed of the particular segment via a weighted average speed computation algorithm.

In one embodiment, the method applies the algorithm for smoothing the values of the average speeds on adjacent segments in accordance with whether or not an average speed is computed and is available for adjacent segments of a road.

In one embodiment, the weighted average speed computation algorithm computes the average speed of a particular road segment as follows:

(i) The method identifies road segments adjacent to the particular road segment: one segment being prior to the particular road segment and the second being after (next) to the particular road segment. For example, a user traverses the prior road segment, followed by the particular road segment, followed by the next road segment.

(ii) The method then determines the weighted speed (smoothed value) for the particular road segment by computing as indicated in Table-2 below. Note that the coefficients used for computing the weighted may be selected by the network service provider. As an illustrative example, for the description below, the coefficients are set as to 0.1 for the prior and next road segments. Thus, the speeds of the adjacent segments contribute 10% each towards the weighted speed of the particular segment.

TABLE 2
Weighted speed of a particular segment (smoothed)

| | | | Weighted speed of |
|---|---|---|---|
| Prior road | Particular road | Next road | the particular road |
| segment | segment | segment | segment (smoothed) |
| Speed missing | Speed computed, | Speed missing | B |
| | set as a value of a | | |
| | parameter B | | |
| Speed computed, | Speed computed, | Speed computed, | (0.1*A) + (0.8*B) + |
| set as a value of a | set as a value of a | set as a value of a | (0.1*C) |
| parameter A | parameter B | parameter C | |
| Speed missing | Speed computed, | Speed computed, | (0.9*B) + (0.1*C) |
| | set as a value of a | set as a value of a | |
| | parameter B | parameter C | |
| Speed computed, | Speed computed, | Speed missing | (0.1*A) + (0.9*B) |
| set as a value of a | set as a value of a | | |
| parameter A | parameter B | | |
| Speed computed, | Speed missing | Speed computed, | (0.5*A) + (0.5*C) |
| set as a value of a | | set as a value of a | |
| parameter A | | parameter C | |
| Speed missing | Speed missing | Speed computed, | Speed not |
| | | set as a value of a | computed |
| | | parameter C | |
| Speed computed, | Speed missing | Speed missing | Speed not |
| set as a value of a | | | computed |
| parameter A | | | |
| Speed missing | Speed missing | Speed missing | Speed not |
| | | | computed |

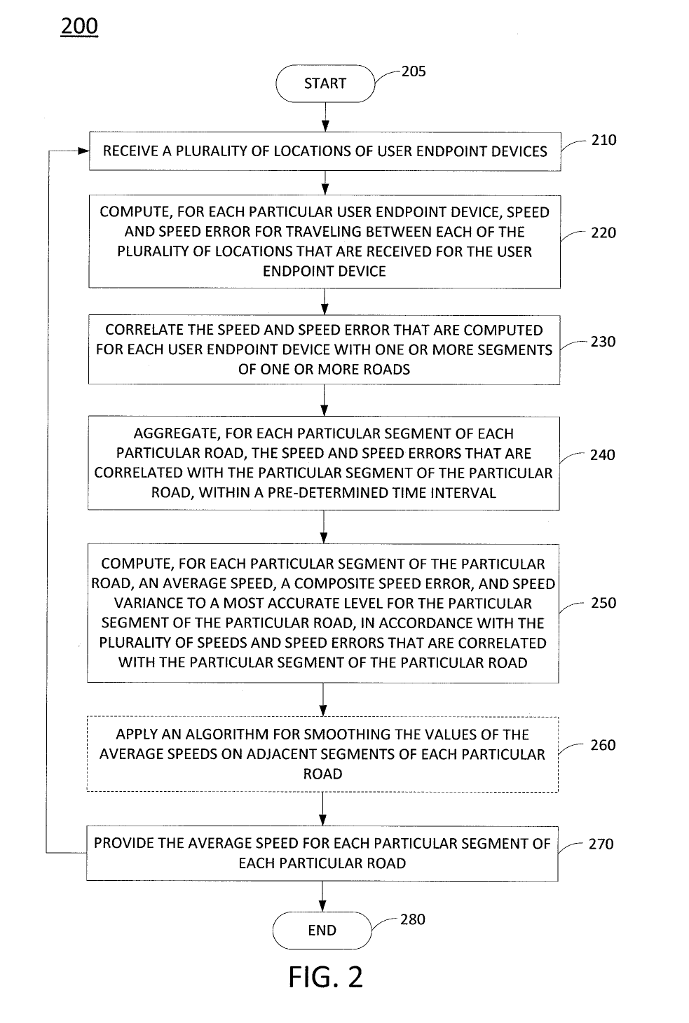

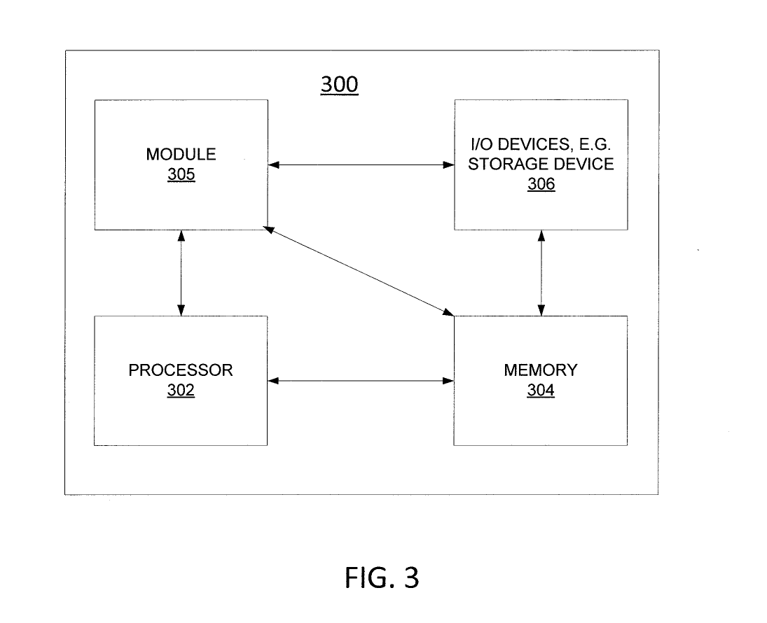

FIG. 2. illustrates a flowchart of a method 200 for estimating the traffic speed for segments of roads using location information of wireless devices in a wireless network. In one embodiment, the method may be implemented in a server, e.g., an application server, or a general purpose computer as discussed in FIG. 3. Method 200 starts in step 205 and proceeds to step 210.

In step 210, method 200 receives a plurality of locations of mobile user endpoint devices. For example, the method receives a plurality of locations (broadly covering location formation such as location coordinates or location data points) for each of a plurality of user endpoint devices.

In step 220, method 200 computes, for each particular user endpoint device, a speed and a speed error for travelling between at least two of the plurality of locations that are received for the user endpoint device. For example, the speed may be computed as the change in location on a particular road divided by the change in time. The speed error may be computed using the location accuracy error of each of the points on a road to which the plurality of locations that are received for the user endpoint device are assigned. For example, the locations Lₙ and L_{c} are assigned to the points Pₙ and P_{c} on a road. Then the speed error is computed using the location accuracy error of the two points of the road to which the locations Lₙ and L_{c} are assigned.

In step 230, method 200 correlates the speed and the speed error that are computed for each user endpoint device with one or more segments of one or more roads. For example, the speeds, that are computed based on the locations of the particular user endpoint device, may be correlated with any number of segments of roads on which the user traveled.

In step 240, method 200 aggregates, for each particular segment of each particular road, the speed and the speed errors that are correlated with the particular segment of the particular road, within a pre-determined time interval. For example, for the example described in Table-1, there were 12 speed and speed errors that were correlated with the particular segment of the particular road within the pre-determined interval of time.

In step 250, method 200 computes, for each particular segment of the particular road, an average speed, a composite speed error, and speed variance to a most accurate level for the particular segment of the particular road, in accordance with the plurality of speeds and speed errors that are correlated with the particular segment of the particular road. For example, the method computes, for a particular segment of the particular road, the average speed and composite speed error based on the most accurate speed. The method then iteratively attempts to improve on the accuracy of the average speed by including a next most accurate speed, until the attempt to improve on the accuracy of the average speed indicates that including the next most accurate speed would degrade the accuracy that was previously computed. The method then determines the average speed, the composite speed error, and the speed variance without including the next most accurate speed and its associated speed error.

In optional step 260, method 200 applies an algorithm or method for smoothing the values of the average speeds on adjacent segments of each particular road. For example, for a same road, since traffic would move sequentially from one segment to the next, the average speed is more likely to transition from segment to segment in a smooth manner. Thus, the method provides an algorithm for smoothing the average speeds for adjacent road segments.

In step 270, method 200 provides the average speed for each particular segment of each particular road. For example, the method may provide the average speed to customers that may be traveling on that road. The method then either proceeds to step 280 to end the estimating of the traffic speed for segments of roads or to step 210 to continue receiving more location information. It should be noted that the average speed of a segment can be represented and/or presented in a number of ways, e.g., as an actual speed number (e.g., 40 miles/hour, 50 miles/hour and so on), as a generic state of the traffic condition (e.g., no traffic, very light traffic, light traffic, average traffic, above-average traffic, very heavy traffic, grid lock traffic), as a color coded graphical display of colored lines representing the traffic conditions on various respective roads (e.g., a green color to represent no traffic to light traffic, a yellow color to represent an average traffic, an orange color to represent very heavy traffic and a red color to represent grid lock traffic), and the like.

FIG. 3 depicts a high-level block diagram of a general-purpose computer suitable for use in performing the functions described herein. As depicted in FIG. 3, the system 300 comprises one or more hardware processor elements 302 (e.g., a central processing unit (CPU), a microprocessor, or a multi-core processor), a memory 304, e.g., random access memory (RAM) and/or read only memory (ROM), a module 305 for estimating the traffic speed for segments of roads using location information of wireless devices in a wireless network, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 305 for estimating the traffic speed for segments of roads using location information of wireless devices in a wireless network (e.g., a software program comprising computer-executable instructions) can be loaded into memory 304 and executed by hardware processor element 302 to implement the steps, functions or operations as discussed above in connection with the exemplary method 200. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for estimating the traffic speed for segments of roads using location information of wireless devices in a wireless network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method for estimating a traffic speed in a wireless network, comprising:
receiving, via a processor, a plurality of locations of a plurality of mobile user endpoint devices;
computing, via the processor, for each respective mobile user endpoint device, a speed and a speed error for travelling between at least two locations of the plurality of locations that are received for each respective mobile user endpoint device;
correlating, via the processor, the speed and speed error that are computed for each respective user endpoint device with one or more segments of one or more roads;
aggregating, via the processor, for each respective segment of each respective road, the speed and the speed error that are correlated with the respective segment of the respective road, within a pre-determined time interval;
computing, via the processor, for each respective segment of the respective road, an average speed, a composite speed error, and a speed variance to a predefined accuracy level for the respective segment of the respective road, in accordance with the plurality of speeds and speed errors that are correlated with the respective segment of the respective road; and
providing, via the processor, the average speed as the traffic speed for each respective segment of the respective road.

2. The method of claim 1, wherein the computing the composite speed error for a respective segment of a respective road to the predefined accuracy level comprises:
sorting the speed and speed errors that are correlated with the respective segment of the respective road, and listing the speed and speed errors that are sorted from a most accurate to a least accurate based on the speed errors; and
computing a series of composite speed errors iteratively until a composite speed error that is computed as greater than at least one of the composite speed errors that were previously computed, wherein a first composite speed error of the series of composite speed errors is computed based on the most accurate speed and speed error, wherein a next composite speed error of the series of composite speed errors is computed by including a next most accurate speed and speed error, until a minimum value is found for the composite speed error.

3. The method of claim 2, wherein the computing the average speed for a respective segment of a respective road to a most accurate level comprises:
computing the average speed for the respective segment of the respective road as an average of the speeds that are associated with the speed errors that were used in computing the minimum value for the composite speed error.

4. The method of claim 3, wherein the computing the speed variance for a respective segment of a respective road to a most accurate level comprises:
computing the speed variance as an average squared deviation of each of the speeds from the average speed that is computed, wherein the speeds were associated with the speed errors that were used in computing the minimum value for the composite speed error.

5. The method of claim 1, further comprising:
smoothing values of the average speeds on adjacent segments of each respective road.

6. The method of claim 5, wherein the smoothing the values of the average speeds is performed in accordance with whether or not an average speed is computed and is available for adjacent segments of the particular road.

7. The method of claim 5, wherein the smoothing the values of the average speeds comprises determining a weighted average speed for each respective road.

8. The method of claim 1, wherein the plurality of locations of mobile user endpoint devices that is received comprises location information that is obtained from one or more of: a global positioning system, a network event location system, proximity information relative to a wi-fi network, proximity information relative to a cell tower, proximity information relative to a femto-cell, triangulation data, differential global positioning system information, and a cell radio identification.

9. A computer-readable storage device storing a plurality of instructions which, when executed by a processor, cause the processor to perform operations for estimating a traffic speed in a wireless network, the operations comprising:
receiving a plurality of locations of a plurality of mobile user endpoint devices;
computing for each respective mobile user endpoint device, a speed and a speed error for travelling between at least two locations of the plurality of locations that are received for each respective mobile user endpoint device;
correlating the speed and speed error that are computed for each respective user endpoint device with one or more segments of one or more roads;
aggregating for each respective segment of each respective road, the speed and the speed error that are correlated with the respective segment of the respective road, within a pre-determined time interval;
computing for each respective segment of the respective road, an average speed, a composite speed error, and a speed variance to a predefined accuracy level for the respective segment of the respective road, in accordance with the plurality of speeds and speed errors that are correlated with the respective segment of the respective road; and
providing the average speed as the traffic speed for each respective segment of the respective road.

10. The computer-readable storage device of claim 9, wherein the computing the composite speed error for a respective segment of a respective road to the predefined accuracy level comprises:
sorting the speed and speed errors that are correlated with the respective segment of the respective road, and listing the speed and speed errors that are sorted from a most accurate to a least accurate based on the speed errors; and
computing a series of composite speed errors iteratively until a composite speed error that is computed as greater than at least one of the composite speed errors that were previously computed, wherein a first composite speed error of the series of composite speed errors is computed based on the most accurate speed and speed error, wherein a next composite speed error of the series of composite speed errors is computed by including a next most accurate speed and speed error, until a minimum value is found for the composite speed error.

11. The computer-readable storage device of claim 10, wherein the computing the average speed for a respective segment of a respective road to a most accurate level comprises:
computing the average speed for the respective segment of the respective road as an average of the speeds that are associated with the speed errors that were used in computing the minimum value for the composite speed error.

12. The computer-readable storage device of claim 11, wherein the computing the speed variance for a respective segment of a respective road to a most accurate level comprises:
computing the speed variance as an average squared deviation of each of the speeds from the average speed that is computed, wherein the speeds were associated with the speed errors that were used in computing the minimum value for the composite speed error.

13. The computer-readable storage device of claim 9, further comprising: smoothing values of the average speeds on adjacent segments of each respective road.

14. The computer-readable storage device of claim 13, wherein the smoothing the values of the average speeds is performed in accordance with whether or not an average speed is computed and is available for adjacent segments of the particular road.

15. The computer-readable storage device of claim 13, wherein the smoothing the values of the average speeds comprises determining a weighted average speed for each respective road.

16. The computer-readable storage device of claim 9, wherein the plurality of locations of mobile user endpoint devices that is received comprises location information that is obtained from one or more of: a global positioning system, a network event location system, proximity information relative to a wi-fi network, proximity information relative to a cell tower, proximity information relative to a femto-cell, triangulation data, differential global positioning system information, and a cell radio identification.

17. An apparatus for estimating a traffic speed in a wireless network, comprising:
a processor; and
a computer-readable storage device storing a plurality of instructions which, when executed by the processor, cause the processor to perform operations, the operations comprising:
receiving a plurality of locations of a plurality of mobile user endpoint devices;
computing for each respective mobile user endpoint device, a speed and a speed error for travelling between at least two locations of the plurality of locations that are received for each respective mobile user endpoint device;
correlating the speed and speed error that are computed for each respective user endpoint device with one or more segments of one or more roads;
aggregating for each respective segment of each respective road, the speed and the speed error that are correlated with the respective segment of the respective road, within a pre-determined time interval;
computing for each respective segment of the respective road, an average speed, a composite speed error, and a speed variance to a predefined accuracy level for the respective segment of the respective road, in accordance with the plurality of speeds and speed errors that are correlated with the respective segment of the respective road; and
providing the average speed as the traffic speed for each respective segment of the respective road.

18. The apparatus of claim 17, wherein the computing the composite speed error for a respective segment of a respective road to the predefined accuracy level comprises:
sorting the speed and speed errors that are correlated with the respective segment of the respective road, and listing the speed and speed errors that are sorted from a most accurate to a least accurate based on the speed errors; and
computing a series of composite speed errors iteratively until a composite speed error that is computed as greater than at least one of the composite speed errors that were previously computed, wherein a first composite speed error of the series of composite speed errors is computed based on the most accurate speed and speed error, wherein a next composite speed error of the series of composite speed errors is computed by including a next most accurate speed and speed error, until a minimum value is found for the composite speed error.

19. The apparatus of claim 18, wherein the computing the average speed for a respective segment of a respective road to a most accurate level comprises:
computing the average speed for the respective segment of the respective road as an average of the speeds that are associated with the speed errors that were used in computing the minimum value for the composite speed error.

20. The apparatus of claim 19, wherein the computing the speed variance for a respective segment of a respective road to a most accurate level comprises:
computing the speed variance as an average squared deviation of each of the speeds from the average speed that is computed, wherein the speeds were associated with the speed errors that were used in computing the minimum value for the composite speed error.
